(19) United States
(12) Patent Application Publication
(10) Pub. No.: US 2013/0061513 A1
(43) Pub. Date: Mar. 14, 2013

(54) FISHING SINKER

(71) Applicant: John J. Grevich, Star Prairie, WI (US)

(72) Inventor: John J. Grevich, Star Prairie, WI (US)

(21) Appl. No.: 13/230,213

(22) Filed: Sep. 12, 2011

(51) Int. Cl. A01K 95/00

(52) U.S. Cl. 43/43.1

(57) ABSTRACT

A fishing sinker that reduces loss of the sinker and other tackle due to being snagged. The sinker includes an elastic portion extending between a first weighted end and a second weighted end. The elastic portion allows the sinker to extend in length when a force is applied thereto, and return to essentially its original length when the force is removed. When a force is applied to the fishing line, the fisherman is able to determine by feel whether the sinker is lodged in a snare or if a fish is on the hook. If the sinker is snagged, when the fisherman applies force to set the hook, the sinker stretches, which the fisherman can feel and thus realize that there is no fish but that the sinker is snagged. When the force is released, the elastic portion snaps back, often resulting in a sling-shot effect dislodging the sinker.

### FIELD OF THE INVENTION

This invention generally relates to fishing devices. In particular, this invention is a sinker weight.

### BACKGROUND OF THE INVENTION

Fishing is supposed to be a tranquil and enjoyable sport. For some types of fishing, particularly trolling, it is desirable to maneuver the hook and bait along or close to the bottom of the lake, river or other waterway. To maintain the hook at the desired level, a weight commonly known as a sinker is attached to the fishing line in close proximity to the hook, either in front of or back from the hook. The weight sinks below the water surface and carries with it the fishing hook.

A problem that occurs with the use of fish line sinkers is that the sinker can sink to the bottom of the stream or lake and get wedged among rocks, logs, and the like. When this happens, unless the fisherman is successful is freeing the sinker, the line has to be broken or cut, resulting in loss of not only the sinker but also the hook and bait.

Additionally, when the sinker first becomes wedged or otherwise snared, the fisherman feels a tug on the line. Most fisherman, thinking that a fish is taking the bait, attempt to ‘set the hook’ by jerking the rod and line. Unfortunately, if it is not a fish but a snared sinker, the result is a broken line and lost sinker, hook and bait.

### BRIEF SUMMARY OF THE INVENTION

The present invention is a fishing sinker that inhibits and preferably eliminates the potential of losing the sinker and other tackle due to being snared among rocks or the like. The sinker of this invention includes an elastic portion extending between a first end for attaching the sinker to a fishing line to a second, weighted end. The elastic portion allows the sinker to extend in length when a force is applied thereto, and return to essentially its original length when the force is removed. The sinker also includes a weight between the first end and the weight at the second end, with the elastic portion extending between the weights; in most embodiments, this weight is close to or at the first end.

The sinker of this invention is not in line between the rod and the hook, but is attached to the line, either before or after the hook, so that the elastic portion does not affect the connection between the fisherman and the hook.

With the sinker of this invention, when a force is applied to the fishing line, the fisherman is able to determine by feel whether the sinker is lodged in a snare or if a fish is on the hook. When the fisherman attempts to set the hook, if it is indeed a fish on the hook, the connection between the rod and the fish is a direct connection via the fishing line, allowing an unhindered motion that hopefully results in a caught fish. However, if the sinker is snared, when the fisherman attempts to set the hook, the elastic portion of the sinker stretches, which the fisherman can feel and thus realize that there is no fish but that it is the sinker that is snared. Knowing that the sinker is snared, the fisherman can attempt to dislodge the sinker from the snag by changing the angle of the line to the snag, for example, by moving the boat backwards. However, the sinker of the present invention, having two weights with an elastic portion therebetween, when force is applied thus causing the elastic portion to stretch, when the force is released the elastic portion snaps back, often resulting in a sling-shot affect dislodging the sinker, thus reducing the situations needs to move the boat and waste precious fishing time.

In one particular embodiment, this invention is to a fishing sinker adapted for attachment to a fishing line. The sinker has an elastic body having a first end and a second end, with a first weight at or proximate to the first end of the body and a second weight at or proximate to the second end of the body. The sinker includes an attachment mechanism at the first end for attaching the sinker to a fishing line. The body may be resiliently bendable and stretchable, so that it can be resiliently deformed by a pulling force to generate a snap back reaction. The body may have a length of at least 3 inches, in some embodiments at least 5 inches. In some embodiments, the elastic body has an elongation potential of at least 50%, or at least 100%; that is, the elastic body can elongate or be stretched at least 50%, or at least 100%. Further in some embodiments, the elastic body has an elongation potential of at least 1 inch, such as of 1 to 4 inches; that is, that is, the elastic body can elongate or be stretched at least 1 inch, such as 1 to 4 inches. Also in some embodiments, the second weight at the second end of the sinker is at least 0.5 ounce greater than the first weight. The elastic body may be tubular. Either or both of the first weight and the second weight may be positioned within a tubular elastic body. In some embodiments, the elastic body is latex.

In another particular embodiment, this invention is to a fishing sinker having a body having a first end and a second end, with the body having an elastic portion between the first end and the second end. A first weight is at the first end of the body and a second weight is at the second end of the body. An attachment mechanism is provided at the first end for attaching the sinker to a fishing line. The elastic portion may be resiliently bendable and stretchable, so that it can be resiliently deformed by a pulling force to generate a snap back reaction.

In another particular embodiment, this invention is to a fishing sinker having an elastic body having a first end and a second end, a first weight at or proximate to the first end of the bod_{y} and a second weight at or proximate to the second end of the body, and an attachment mechanism at the first end for attaching the sinker to a fishing line. The sinker is resiliently bendable and resiliently stretchable, so that it can be resiliently deformed by a pulling force to generate a snap back reaction.

These and various other features and advantages of the invention will be apparent from a reading of the following detailed description.

### BRIEF DESCRIPTION OF THE DRAWING

The invention may be more completely understood in consideration of the following detailed description of various embodiments of the invention in connection with the accompanying drawing, in which:

FIG. 1 is a perspective view of a sinker according to the present invention attached to a fishing line;

FIG. 2 is a side plan view of a first embodiment of a sinker according to the present invention;

FIG. 3 is a cross-sectional view taken along line 3-3 of FIG. 2;

FIG. 4A is a side plan view of an alternate embodiment of a sinker according to the present invention in a relaxed state; FIG. 4B is the sinker in an elongate state; and

FIG. 5 is a side plan view of another embodiment of a sinker according to the present invention.

### DETAILED DESCRIPTION OF THE INVENTION

The present invention is a fishing sinker having an elongate elastic portion extending between a first weight proximate the end of the sinker for attaching the sinker to a fishing line and a second weight, proximate the other end of the sinker. The elastic portion allows the sinker to extend in length when a force is applied thereto, and to return to essentially its original length when the force is removed.

In the following description, reference is made to the accompanying drawing that forms a part hereof and in which are shown by way of illustration various specific embodiments. The description provides additional specific embodiments. It is to be understood that other embodiments are contemplated and may be made without departing from the scope or spirit of the present invention. The following Detailed Description, therefore, is not to be taken in a limiting sense. While the present invention is not so limited, an appreciation of various aspects of the invention will be gained through a discussion of the examples provided below.

Unless otherwise indicated, all numbers expressing feature sizes, amounts, and physical properties are to be understood as being modified by the term “about.” Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

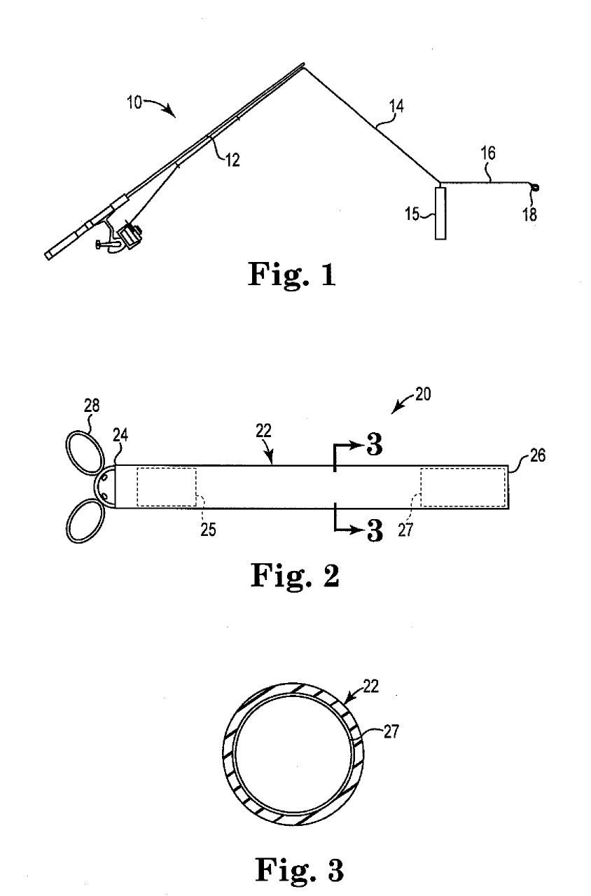

FIG. 1 illustrates a conventional fishing set-up 10 particularly adapted for trolling. Set-up 10 includes a rod and reel 12 from which extends a fishing line 14. In this embodiment, line 14 extends to sinker 15 and a trailing leader 16 with a hook 18. In an alternate embodiment, sinker 15 may be connected to line 14 via a leader trailing the hook.

In both embodiments, a direct line of connection exists between rod 12 and hook 18. For the illustrated embodiment, the direct connection is via line 14 and leader 16. In the alternate embodiment, a direct line of connection exists directly from rod 12 to hook 18 via line 14. This direct line from rod 12 to hook 18 is desired when attempting to set-the-hook, as the direct line allows an unhindered motion that hopefully results in a caught fish.

Referring to FIG. 2, a sinker 20 according to the invention is illustrated. Sinker 20 has an elastic body 22 having a first end 24 and an opposite second end 26; additional details regarding body 22 are provided below. At or proximate to first end 24 is a first weight 25 and at or proximate second end 26 is a second weight 27.

Each of weights 25, 27 are preferably fit within body 22 by friction fit, as best seen in FIG. 3. In most embodiments, adhesive, clips, etc. are not used to hold weights 25, 27 in their desired location, but such means could be used. Although weights 25, 27 have been illustrated as being positioned within a tubular body 22, in alternate embodiments one or both weights 25, 27 may be present external to body 22. For example, either or both weights 25, 27 could be an annular weight that is present around body 22, or either or both weights 25, 27 could be one or more individual weights that are attached on the surface of body 22 (for example, multiple individual weights could be evenly spaced around the other circumference of body 22). In this embodiment, each of weights 25, 27 are completely encased by or within body 22.

Each of weights 25, 27 is typically at least 0.5 ounces and may be as much as 8 ounces, depending on the overall rigging, the desired depth of the hook and the target fish. In some embodiments, weight 27 at second end 26 (i.e., the free end) is greater than weight 25 at first end 24 by at least about 0.5 ounce, by at least about 1 ounce, or by at least about 2 ounces. As an example, weight 25 may be 1 ounce and weight 27 may be 1.5 ounces, such as when fishing for Walleye; as another example, such as when fishing for Muskellunge (Muskie), weight 25 may be 3 ounces and weight 27 may be 4 ounces.

Either or both weights 25, 27 may be a single mass, as illustrated, or may be formed from a plurality of weights, e.g., shot or ball bearings. If formed by a plurality of weights, it is preferred that weights 25, 27 be fixed in their location at ends 24, 26, respectively, to deter movement of any part of weights 25, 27. Sinker 20 may be designed to allow the addition or removal of weight from either end 24, 26, for example, to alter the buoyancy characteristics of sinker 20. Weight may be added internally (e.g., placed within body 22) or externally (e.g., hung at end 26).

Sinker 20 includes an attachment mechanism 28 at first end 24, for connecting sinker 20 to fishing line 14 (FIG. 1). The illustrated attachment mechanism 28 is fixedly attached to first end 24 and having two swivel attachment points, one for attaching to line 14 from rod 12 and one for attaching to leader 16 extending to hook 18, if sinker 20 is configured for positioning between rod 12 and hook 18. The attachment mechanism 28 can be mounted to sinker first end 24 by convention means, such as by a U-shaped wire connector, by adhesive, or any other suitable means. In another embodiment, attachment mechanism 28 can be a 3-way coupler, having three coupling eyelets, with first end 24 attached to one eyelet, fishing line 14 from rod 12 attached to a second eyelet and leader 16 to hook 18 attached to the third eyelet. Typically, line 14 and leader 16 are removably attached to attachment mechanism 28.

For embodiments where sinker 20 is configured for trailing the hook, attachment mechanism 28 may have only one location in addition to the attachment to first end 24 of sinker 20.

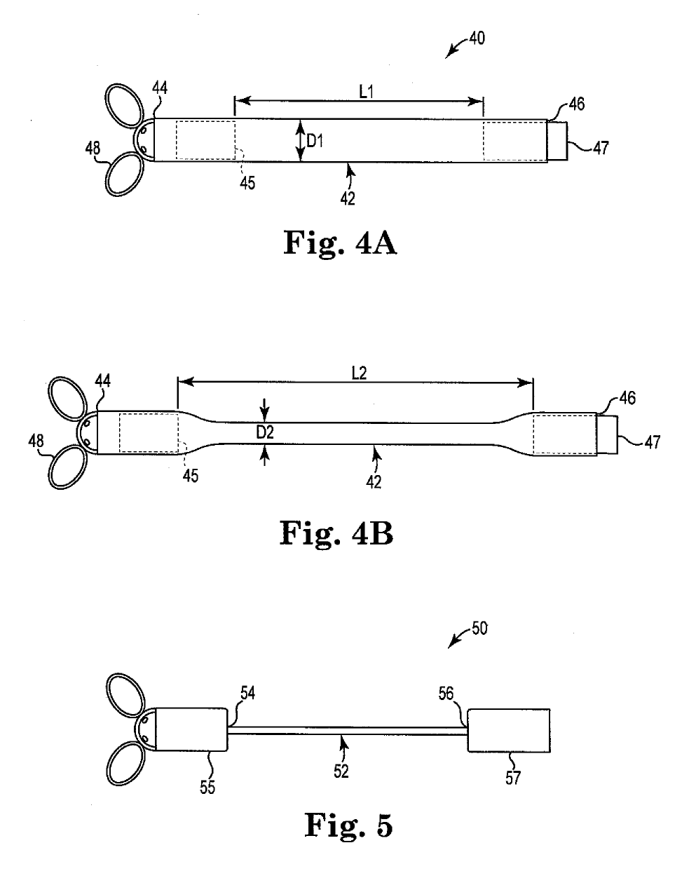

Referring to FIGS. 4A and 4B, another embodiment of a sinker is illustrated as sinker 40. The various features of sinker 40 are the same as or similar to the like features of sinker 20, unless indicated otherwise. Sinker 40 has an elastic body 42 having a first end 44 and an opposite second end 46. At or proximate to first end 44 is a first weight 45 and at or proximate second end 46 is a second weight 47. In this embodiment, a portion of weight 47 extends out from body 42. Sinker 40 includes an attachment mechanism 48 at first end 44 for connecting sinker 40 to fishing line 14 (FIG. 1).

Body 42 (and body 22) is at least partially composed of elastic; that is, at least a portion of the length between weight 45 and weight 47 is elastic. By use of the term “elastic” as a noun, what is intended is a material is stretchable and has a memory. That is, the material can extend in length when a force is applied thereto, and return to essentially its original length when the force is removed. The material should also be sufficiently flexible laterally, to allow bending, twisting and wiggling of sinker 40. Examples of suitable elastic materials include polymeric materials (e.g., elastomeric materials, either thermoset or thermoplastic), latex, natural rubber, and materials made with those materials (e.g., reinforced rubber). One particularly preferred material for body 40 is latex ⅜ inch surgical tubing. The material selected for body 42 should maintain flexibility and stretchability at cold temperatures, e.g., at about 35° F. Preferably, the material is also deformable and compressible laterally, with memory to return to essentially its original configuration.

Additionally or alternatively, at least a portion of body 42 (and body 22) is elastic; that is, at least a portion of body 42 between weight 45 and weight 47 has elastic properties. By use of the term “elastic” as an adjective, what is intended is stretchability or elongation with a memory. An example of a body that may be elastic but not composed of an elastic material is a body made from woven or knitted non-elastic material, elongation of which is due to elongation of the weave or knit.

The material of body 42 may be buoyant, have negative buoyancy, or be neutral. The material may be porous or non-porous, and may have any color. Although sinker 40 is not intended as a lure for the fish, in some embodiments it may be desired to include a visual attractant, such as a fluorescent color or metallic surface. Additionally, body 42 may be configured to receive and/or dispense an attractant such as a flavor (e.g., salt) or scent. Body 42 may have an aperture or may be sufficiently porous to release the attractant in a controlled manner.

Referring again to FIGS. 4A and 4B, FIG. 4A illustrates sinker 40 in a first orientation, with body 42 having a length L1 between weight 45 and weight 47 and a diameter D1. When a stretching force is applied (such as when second end 47 of sinker 40 is snagged), body 42 extends to length L2 having diameter D2. The elastic portion of body 22 preferably allows a length increase of at least 25% in body 42 from L1 to L2, in most embodiments at least 50%. An increase of at least 100% or even more is also suitable. As an example, a 100% increase of a 2.5 inch length L1 would be a 5 inch length L2. Diameter D2 may or may not differ from diameter D1, based on the configuration and properties of body 42. In some embodiments, as body 42 stretches, the diameter decreases about 10% from D1 to D2, although more or less decrease may be suitable. Sinker 40, and other sinkers such as sinker 20, are generally described as “elongate”, having a length significantly greater than the diameter, both in a relaxed state and an elongated or stretched state.

In its relaxed state, e.g., as in FIG. 4A, sinker 40 typically has a length of about 5 to 6 inches long, but could be longer, such as 8 to 9 inches, or shorter, such as 3 or 4 to 5 inches. In its elongated state, e.g., as in FIG. 4B, sinker 40 typically has a length that is 1 to 4 inches longer than when in its relaxed state, sometimes 2 to 3 inches. For example, a 6 inch sinker 40 may extend to 7 inches, or to 10 inches.

Further, in its relaxed state, sinker 40 typically has a distance of at least 1 inch between weight 45 and weight 47, often at least about 2 inches. Having at least 1 or 2 inches, in some embodiments at least 3 inches, between weights 45, 47 allows the resiliency of body 42 to inhibit potential snag locations. If sufficient distance is between weights 45, 47, free end weight 47 can move independently (e.g., twist, bounce, wiggle, etc.) to inhibit becoming snagged. Additionally, having at least 1 or 2 or 3 inches between weights 45, 47 increases the sling-shot effect.

FIG. 5 illustrates another embodiment of a sinker as sinker 50. The various features of sinker 50 are the same as or similar to the like features of sinker 20 and sinker 40, unless indicated otherwise. Sinker 50 has an elastic body 52 having a first end 54 and an opposite second end 56. At or proximate to first end 54 is a first weight 55 and at or proximate second end 56 is a second weight 57. In this embodiment, body 52 has a diameter than is significantly less than the diameters of weights 55, 57.

In the previous embodiments, i.e., sinker 20 and sinker 40, body 22 and body 42 are tubular, with the weights present in the interior void of the tubular body. In FIG. 5, body 52 of sinker 50 is not tubular, but a solid elastic material, having a diameter significantly less than weights 55, 57.

It will be appreciated that the sinkers of this invention are designed to hang down or depend from the fishing line and under various conditions, will be dragged along the river or lake bottom. In use, the sinker is oriented with the weighted free end lower than the weighted upper end. It is not uncommon that a depending sinker will pulled into a crevice formed between adjacent rocks, or below a log or branch, and become wedged and held fast.

As discussed above, the elastic body is beneficial for a fisherman when trolling along a rocky bottom. Because of the resilient and elastic nature of the sinker body, the sinker has a tendency to bounce off of or otherwise avoid rocks and other potential snag locations. The elastic body allows the weighted free end to move independently (e.g., twist, bounce, wiggle, etc.) to inhibit becoming snagged.

Also discussed above, the elastic body together with the two weights is beneficial for a fisherman when the sinker is snagged. When tension increases on the line, due to either a snag or a fish on the hook, the fisherman will attempt to set the hook. If the sinker is snagged, when the fisherman attempts to set the hook, rather than the abrupt motion breaking the line and resulting in loss of the sinker, hook and bait, the forgiving sinker stretches, typically a sufficient length to accommodate the hook setting motion without breaking the line. Additionally, the stretch of the body feels different than having a fish on the hook, indicating to the fisherman that there is no fish but that it is the sinker that is snared. Knowing that the sinker is snared, the fisherman can attempt to dislodge sinker 40 from the snag by changing the angle of the line to the snag, for example, by moving the boat backwards. Preferably, the hook setting force is sufficiently great that upon removal of the force from the first end of the sinker, the elastic portion (e.g., the body) snaps back, and with the upper or first weight, results in a sling-shot affect often dislodging the sinker from the rock pile or log on which the sinker is snared, thus eliminating the need to move the boat and waste good fishing time.

Thus, embodiments of FISHING SINKER are disclosed. Various modifications and alterations of this invention will become apparent to those skilled in the art without departing from the scope and spirit of this invention, and it should be understood that this invention is not to be unduly limited to the illustrative embodiments set forth herein. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A fishing sinker adapted for attachment to a fishing line, the sinker comprising:
an elastic body having a first end and a second end, a length of at least 3 inches, and an elongation potential of at least 50%;
a first weight at or proximate to the first end of the body and a second weight at or proximate to the second end of the body; and
an attachment mechanism at the first end for attaching the sinker to a fishing line.

2. The fishing sinker of claim 1 wherein the elastic body has length of at least 5 inches.

3. The fishing sinker of claim 1 wherein the elastic body has an elongation potential of at least 100%.

4. The fishing sinker of claim 1 wherein the elastic body has an elongation potential of at least 1 inch.

5. The fishing sinker of claim 1 wherein the elastic body has an elongation potential of 1 to 4 inches.

6. The fishing sinker of claim 1 wherein the second weight is at least 0.5 ounce greater than the first weight.

7. The fishing sinker of claim 1 wherein the elastic body is tubular and the first weight and the second weight are positioned within the elastic body.

8. The fishing sinker of claim 1 wherein the elastic body comprises latex.

9. A fishing sinker adapted for attachment to a fishing line, the sinker comprising:
a body having a first end and a second end, the body comprising an elastic portion between the first end and the second end having an elongation potential of at least 1 inch;
a first weight at the first end of the body and a second weight at the second end of the body; and
an attachment mechanism at the first end for attaching the sinker to a fishing line.

10. The fishing sinker of claim 9 wherein the elastic portion has an elongation potential of at least 50%.

11. The fishing sinker of claim 9 wherein the elastic portion has an elongation potential of at least 100%.

12. The fishing sinker of claim 9 wherein the elastic portion has an elongation potential of at least 3 inches.

13. The fishing sinker of claim 9 wherein the second weight is at least 0.5 ounce greater than the first weight.

14. The fishing sinker of claim 9 wherein the body is tubular.

15. A fishing sinker adapted for attachment to a fishing line, the sinker comprising:
an elastic body having a first end and a second end;
a first weight at or proximate to the first end of the body and a second weight at or proximate to the second end of the body; and
an attachment mechanism at the first end for attaching the sinker to a fishing line, the sinker being resiliently bendable and resiliently stretchable, so that it can be resiliently deformed by a pulling force to generate a snap back reaction.

16. The fishing sinker of claim 15 wherein the second weight is at least 0.5 ounce greater than the first weight.

17. The fishing sinker of claim 15 wherein the second weight is at least 1 ounce greater than the first weight.

18. The fishing sinker of claim 15 where a distance between the first weight and the second weight is at least 1 inch.

19. The fishing sinker of claim 15 where a distance between the first weight and the second weight is at least 2 inches.

20. The fishing sinker of claim 15 where a distance between the first weight and the second weight is at least 3 inches.
